(19) United States
(12) Patent Application Publication
(10) Pub. No.: US 2012/0260521 A1
(43) Pub. Date: Oct. 18, 2012

(54) PAINT SPRAY BOOTH SYSTEM

(76) Inventors: Michael H. Bunnell, Plymouth, MI (US); James M. Bunnell, Westland, MI (US); Richard J. Hahn, Northville, MI (US); Paul R. Hahn, Canton, MI (US)

(21) Appl. No.: 13/502,875

(22) PCT Filed: Oct. 22, 2010
(86) PCT No.: PCT/US10/53665

§ 371 Date: Jul. 6, 2012

Related U.S. Application Data
(60) Provisional application No. 61/254,018, filed on Oct. 22, 2009.
(60) Provisional application No. 61/357,826, filed on Jun. 23, 2010.

(51) Int. Cl. B05B 15/12; F26B 25/06

(52) U.S. Cl. 34/666

(57) ABSTRACT

A paint drying booth includes a stationary structure of sidewalls, and a pair of opposed end walls including an access door for egress and ingress. A turbo-compressor is disposed exteriorly of the booth and delivers through a duct heated turbine air thereinto. The duct is in fluid communication with a nozzle which, in turn, is in fluid communication with an air knife having a slit which delivers turbulent air into the interior of the booth. A pair of diametrically opposed panels are disposed at the junction of the corners of the booth upon which air from the air knife impinges thereon to create a vortex within the booth. Optimally, a five bladed turbo-compressor is used. A seven bladed turbo-compressor may be used and which also delivers heated air to a spray gun disposed within the booth by a diverter.

### CROSS-REFERENCE TO RELATED APPLICATION

This application is a completion application of co-pending U.S. Provisional Application Ser. No. 61/254,018, filed Oct. 22, 2009 for “Paint Spray Booth System” and Ser. No. 61/357,826, filed Jun. 23, 2010, for “Paint Spray Booth System”, the disclosures of which are hereby incorporated by reference in their entireties, including the drawings.

### FIELD OF THE INVENTION

The present invention pertains to paint spray booths. More particularly, the present invention pertains to the drying of aqueous-based paints in a paint spray booth. Even more particularly, the present invention concerns paint spray booth systems utilizing turbine air for both spraying and drying of aqueous-based paints.

### FIELD OF THE INVENTION

As is known to those skilled in the art to which the present invention pertains, the automotive industry is being switched from solvent-based paints to water-based paints because of their use of volatile organic chemicals (VOCs). The elimination of VOCs for environmental purposes is well documented. However, the utilization of water-based paints creates issues ordinarily not encountered with solvent-based paints. Water-based paints ordinarily require more time for drying than solvent-based paints. For example a three layer application of solvent-based paint for a small repair job, at an ideal temperature, may take 70 to about 180 minutes to dry while the same task with a water-based color coat, alone, without primer or top coat paint might take about 30 to about 180 minutes, by itself. Thus, in high humidity environments water-based paints are more costly to use. Similarly the drying times involved with these paints are a serious impairment in their efficiency. Thus, there exists a great need for accelerating the drying time of items, such as, automobiles and automotive parts which are spray painted with aqueous based paints. It is to this to which the present invention is directed.

### SUMMARY OF THE INVENTION

The present invention provides an improved turbo-compressor driven paint spray booth. The booth, itself, generally comprises an enclosure having a pair of upstanding sidewalls, a rear wall, a front wall, a roof and open interior. An access is provided for both ingress and egress into the booth.

A turbo-compressor delivers heated air into the interior of the booth. The duct is in fluid communication with a nozzle which, in turn, feeds into at least one knife sprayer. The knife sprayer is a housing having an elongated slit which issues hot air therefrom into the interior of the booth with a turbulent air into the booth.

At least a pair of diametrically opposed air flow panels are disposed within the booth, preferably, at the corners thereof.

The knife sprayers have their respective air slits oriented toward an adjacent corner of the room having an air flow panel thereat. The turbo-compressor preferably, comprises a five bladed or five stage turbine.

Also, in lieu thereof, a seven bladed turbine or seven stage turbine can be used for both drying and spraying within the booth as desired.

For a more complete understanding of the present invention reference is made to the following detailed description and accompanying drawing. In the drawing like reference characters refer to like parts throughout the several views in which:

### BRIEF DESCRIPTION OF THE DRAWINGS

FIG. 1 is a cut away side elevation view of a first embodiment of a paint spray system in accordance with the present invention;

FIG. 2 is a partial perspective view depicting a portion of the interior of a paint spray booth used in the present paint spray system;

FIG. 3 is a second partial perspective view of a paint spray system in accordance with the present invention;

FIG. 4 is a perspective view of a knife sprayer used in the practice of the present invention;

FIG. 5 is a partial cross-sectional view of a turbo-compressor used herein;

FIG. 6 is a partial perspective view of the drive shaft and rotor-stator arrangement of the turbo-compressor, taken along line 5-5 of FIG. 6, and

FIG. 7 is a side elevation view of a second embodiment of a paint spray system in accordance with the present invention;

FIG. 8 is a perspective view of an enshrouded turbo-compressor used in the practice of the present invention, and

FIG. 9 is a side view of an alternate embodiment of a knife sprayer used in the practice herein;

FIG. 10 is a plan view of the sprayer of FIG. 9;

FIG. 11 is a bottom view thereof;

FIG. 12 is a perspective view of the top of the compressor with the cover removed, and

FIG. 13 is a top plan view of a preferred cover for the compressor.

### DESCRIPTION OF THE PREFERRED EMBODIMENT

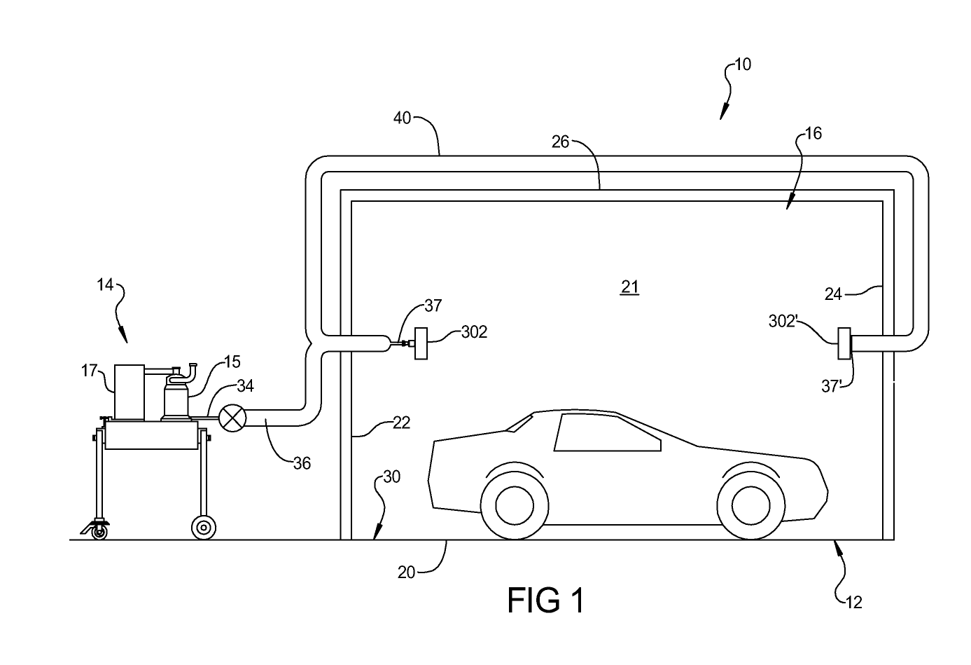

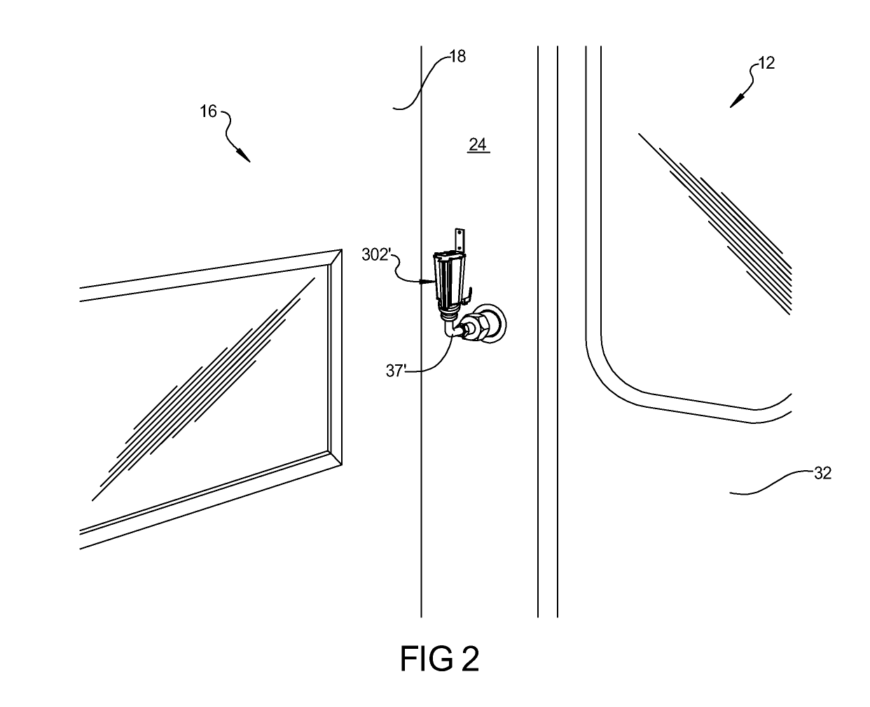

Now, and with reference to the drawing, and in particular FIGS. 1-4 there is depicted therein a first embodiment of a paint spray system in accordance with the present invention and generally denoted at 10. The system 10 hereof nominally comprises a paint spray booth 12 and a turbine 14 for generating heated air for introduction into the booth 12.

More particularly, the paint spray booth 12 hereof comprises an enclosure 16 having a pair of upstanding sidewalls 18, (only one of which is shown); a rear wall 22, a front wall 24, a roof 26 and an open interior 21. Typically, a ground surface such as a floor 30 comprises a base or bottom 20 of the booth.

An access, such as a hinged door or other closure 32 is provided for both ingress and egress into the booth. Although not shown in the drawing, the booth, itself, may include all of the traditional peripheral equipment typically associated therewith such as lights, drains, and the like.

As detailed hereinbelow, the booth 12 further comprises at least one knife sprayer 302 and at least one air flow panel 304.

The turbine 14 which is more fully described below includes a compressor 35 and is used to deliver heated air to the interior 21. The turbine 14, preferably, seats upon a wheeled stand for portability. The air issuing from the turbine, generally, ranges from about 80° F. to about 240° F. above the ambient temperature of the air entering the compressor 35 of the turbine 14.

Generally, and as shown, a conduit 34 extends from the turbine 14 and is in fluid communication with a first duct 36 disposed above the floor 20. The conduit 34 is detachably mounted to the duct 36 by any suitable means, such as by friction, clamping, or the like (not shown).

The duct 36 extends into the booth interior 21 at any convenient location within the booth, preferably, on the rear end wall 22. The duct 36 is stationary and delivers heated air a knife sprayer 302 into the interior 21 of the spray booth.

A reduced diameter nozzle 37, which extends into an associated knife sprayer 302, is detachably mounted to the duct 36 by any suitable means, such as with a clamp, a function fit, a threaded attachment or the like.

A second duct 40 is split off from the duct 36 and extends therefrom. The duct 40 terminates at a second reduced diameter nozzle and 37′. Similar to the nozzle 37, the nozzle 37′ is disposed in the interior 21 of the booth 12. The nozzle 37′ is disposed within the interior 21 within an associated knife sprayer 302. Preferably, the second sprayer 302, is diametrically opposed to the nozzle 37 and is mounted to the front wall 24 at substantially the same height as that of the nozzle 37.

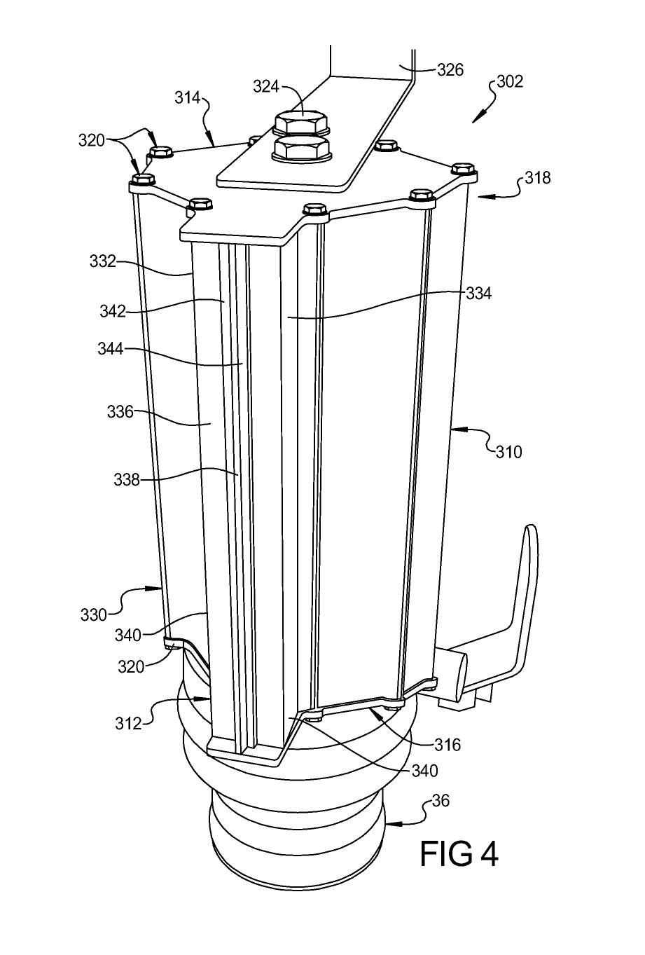

Since the nozzle and knife sprayer assemblies are identical, for purpose of clarity, only one will be described. As illustrated in FIG. 4, the knife sprayer 302 is mounted over or atop the reduced diameter nozzle 37 and is connected to the duct 36 by conventional means, such as clamping with a hose clamp or the like. The knife sprayer 302 may be coupled in a similar manner to the duct 36. The knife sprayer 302 is designed to discharge a stream of high temperature pressurized air within the open interior 21 to create improved air circulation and paint drying time within the paint spray booth 12.

As shown, the knife sprayer 302 comprises a generally cylindrical body 310, a spray projection or slit 312, a top plate 314 and a bottom plate 316. The top plate 314 is secured to a first end 318 of the body 310 and the spray projection 312 by conventional means, such as by screws 320 or other suitable means for fastening. The top plate 314 may also include an aperture 322 to accept a bolt 324 which engages a support bracket 326. The bolt 324 may be inserted through an aperture (not shown) in the support bracket 326 and the aperture 322 to secure the support bracket 326 to the top plate 314. The support bracket 326 may then be fastened, such as with a bolt or screw or the like to a wall of the paint spray booth to provide support and stabilization to the knife sprayer 302.

The bottom plate 316 includes a central aperture 328 and is coupled to a second end 330 of the body 310 and the spray projection 312 by conventional means. The central aperture 328 may have a diameter sized to fittingly engage the duct 36 or nozzle 37. The body 310, the top plate 314 and bottom plate 316 form a generally enclosed hollow cylinder.

The spray projection 312 extends from the body 310 and includes a first side 332, a second side 334, a third side 336 and an air slit 338. The first and second sides 332, 334 are spaced in parallel and project generally orthogonal to the body 310. The third side 336 is orthogonal to the distal ends 340 of the first and second sides 332, 334. The air slit 338 is a narrow gap along the length of the third side 336 through which compressed air may travel. The third side 336 may also include a first flange 342 and a second flange 344 projecting therefrom on either side of the air slit 338.

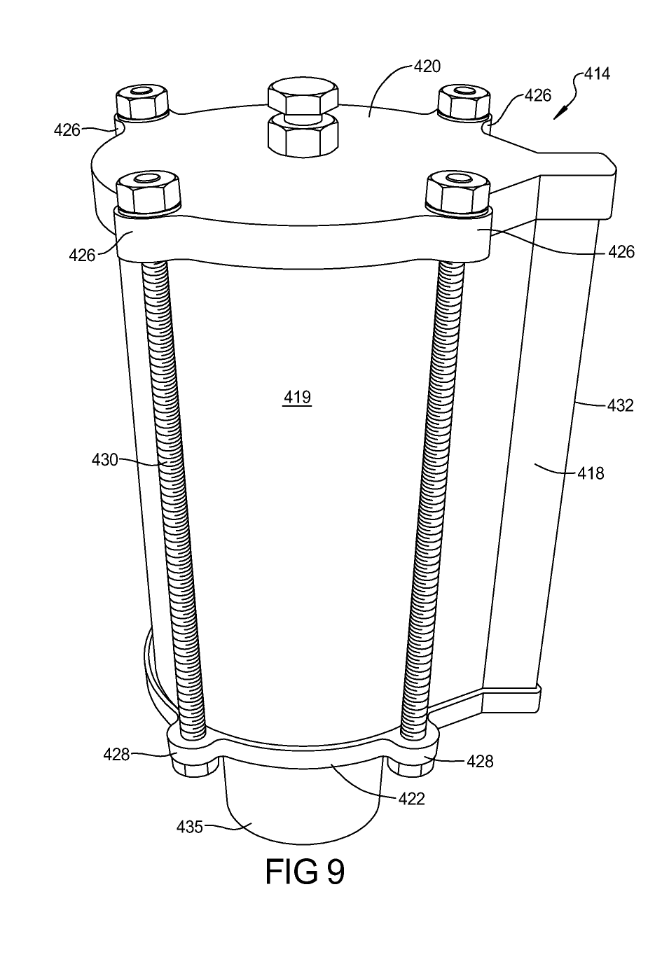

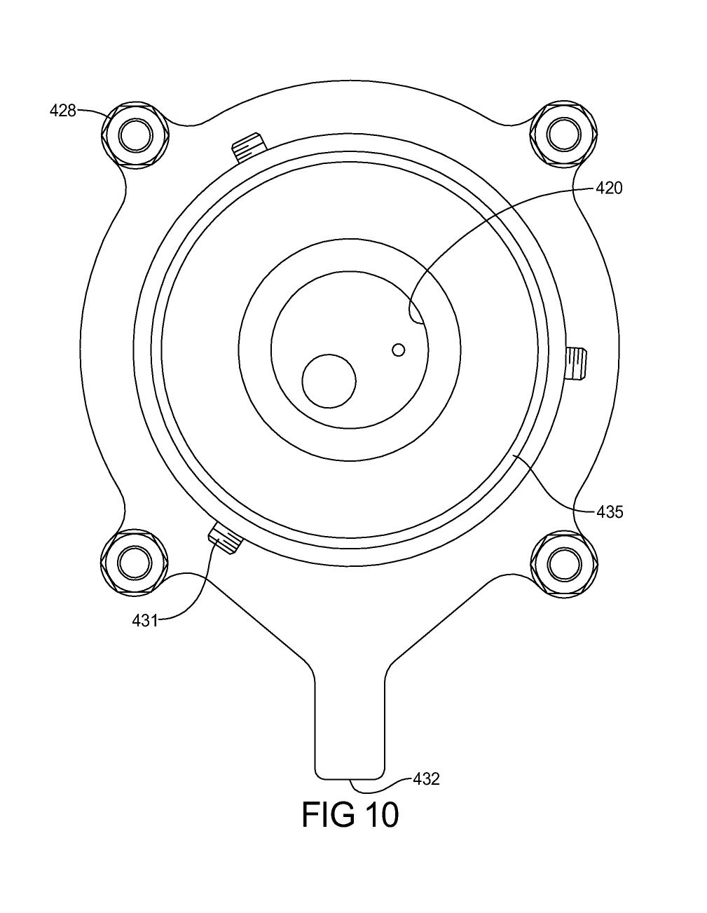

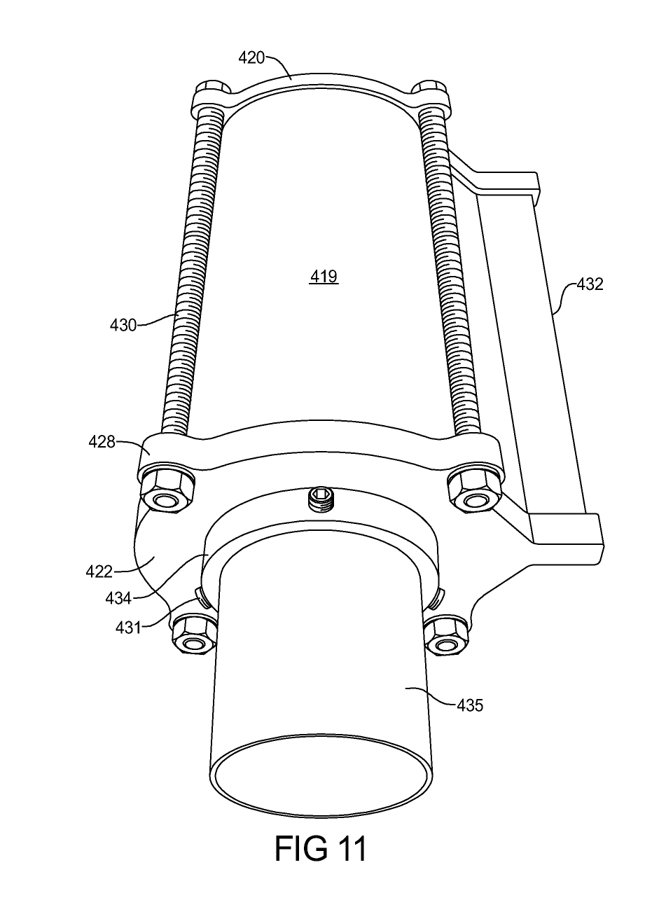

Referring now to FIG. 9 there is depicted therein a particularly preferred spray assembly generally, denoted 410 and comprising a reduced diameter nozzle 412 and knife 414.

The nozzle 412 is a substantially cylindrical member which is detachably secured or otherwise affixed to the duct 36 at the free end thereof. The nozzle 412 is a substantially cylindrical body 413 which terminates in a tapered reduced diameter portion 416. The nozzle 414 is disposed within the interior of the knife 414. From a physical standpoint the nozzle reduces down and terminates in a substantially ¾ inch opening through which turbine air issues into the knife or knife sprayer 414.

The knife 414 comprises a housing 418 having an open interior 420 into which the nozzle 412 extends. The housing is a substantially cylindrical member having upper and lower plates 420, 422. Each plate 420, 422 has an associated flange, 426 and 428, through which fastening members, such as bolts, 430 are used to secure the upper plate and the lower plate together to secure the assembly together.

Each of the plates, although not shown, is provided with an interior groove which seats the upper and lower edges of the housing to provide a secure fit and nested fit to thereby control the opening of the slit.

The housing has a slit 432 through which air is issued into the interior of the booth 12.

A tube 435 is integral with the body 419 and is in fluid communication with the interior 420 of the body 419. The tube 435 is a receptor for the nozzle and associated duct which projects there through.

In mounting the nozzle 412 to the housing a pair of spaced-apart fitting rings 434 are used. The first or lower ring 434 is disposed below the lower-most plate and is fixed in position by a set screw 431 or other suitable fastening means.

An opposing ring (not shown) is disposed above the lower most plate in a similar fashion and is fixed in the same manner using a set screw or the like. The rings enable the nozzle 412 to be adjustably disposed and positioned within the interior of the housing and can, thus, be raised higher into the interior or lowered, as desired.

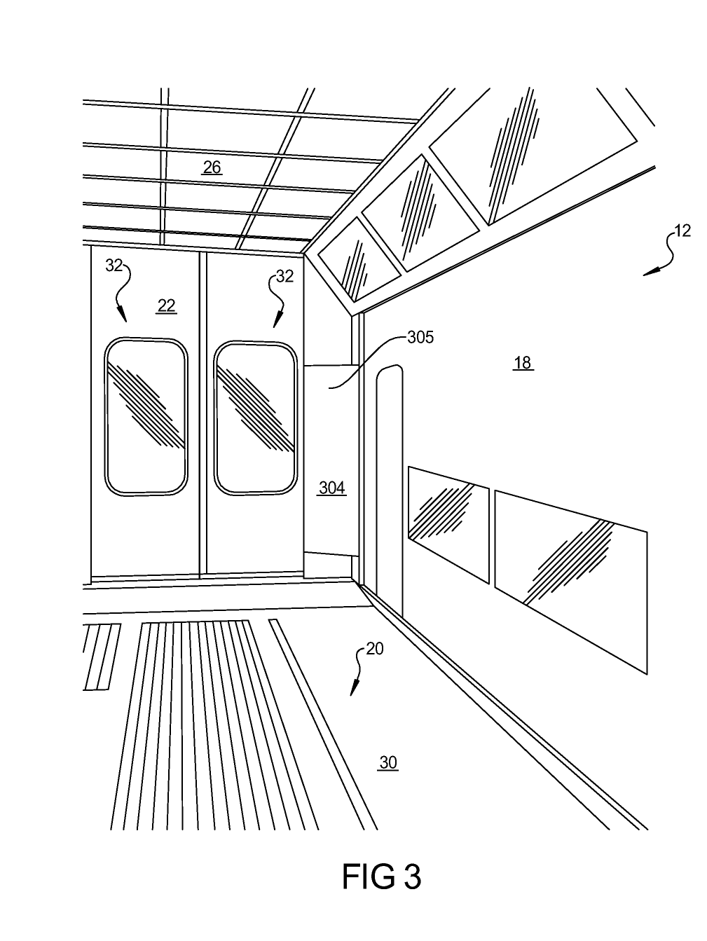

Referring, again, to FIG. 3, as noted above, the present booth, also, comprises at least one and, preferably, a pair of diametrically opposed air flow panels 304. The air flow panels 304 are generally rectangular sheets made of metal, wood or other suitable sturdy material having a convex surface 305. The air flow panels 304 are optimally located in corners of the paint spray booth where a duct 36 and/or knife sprayer 302 is absent. Preferably, at least one and preferably or least a pair of air flow panels 304, 304′ are located in opposite corners of the paint spray booth 12 between the sidewall 18 and the rear wall 22 and the sidewall 18 and the front wall 24 respectively. A knife sprayer 302, 302′ or 410 is located in the two remaining corners of the paint spray booth 12. The air flow panels 304 operate to smooth the 90 degree angle between the walls of the paint spray booth 12 to create a circular flowing motion of air within the enclosure 16.

In operation, the air issuing from the turbine 14 travels through the conduit 34, the duct 36, the reduced diameter nozzles to the interior of the body of the knife sprayer. The air is then forced through the narrow air slit of the spray projection. By decreasing the exit area for the air through the narrow air slit, the velocity of the air entering the interior of the paint spray booth is drastically increased.

The air slit is preferably pointed towards an adjacent corner of the room having the air flow panel or wherever else a panel may be disposed. Directing the air in this manner creates a vortex motion of high velocity heated air within the paint spray booth that significantly reduces drying time of paint on objects in the paint spray booth 12.

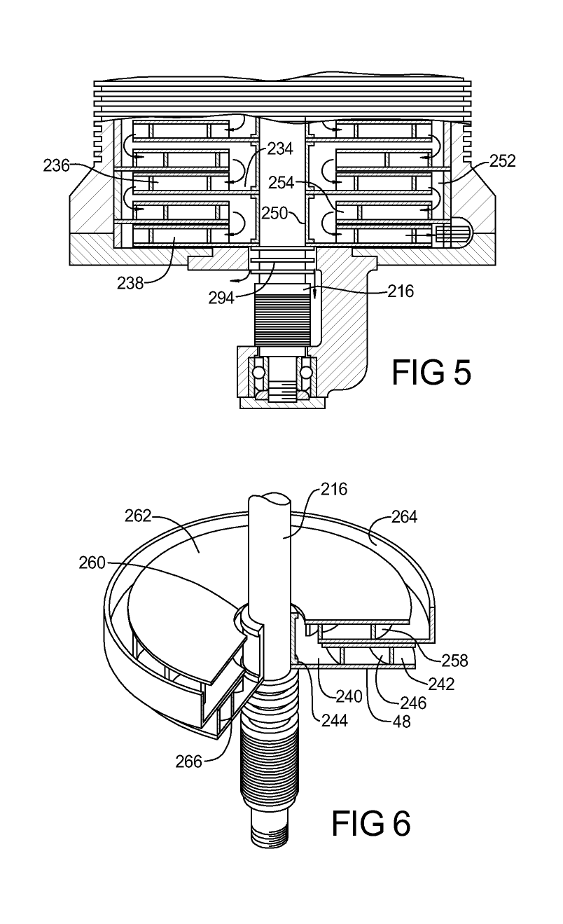

In practicing the percent invention and with reference to FIGS. 5 and 6, the turbine 14, preferably, comprises a five bladed or five stage turbine.

The turbine14 delivers air to the paint spray booth 16 at an elevated pressure and temperature.

The turbine or turbo-compressor 14, generally includes a housing and a rotatable, vertically-disposed drive shaft centrally disposed within the housing, and a bearing housing which houses a concentrically disposed bearing. The turbo-compressor further comprises a rotatable section centrally disposed about the shaft. The section includes a first rotor and a second rotor. The rotors are coaxial with the shaft.

Each rotor comprises a first series of blades spirally arrayed about the center of the shaft. The first series of blades are sandwiched between a first pair of plates. The rotors are rotatably driven in the same direction as the shaft, as air is directed onto and through the blades. The rotatable section also includes a tubular sleeve which is mounted about the shaft. The sleeve separates the rotors, and the sleeve is rotatable with the rotors and the shaft in the same direction as the rotors and the shaft. The turbo-compressor also includes a stationary section, which is centrally disposed about the shaft. The stationary section includes a stator, which comprises a series of vanes spirally arrayed around the center of the central passage. The vanes are sandwiched between a pair of stator plates. The stator, like the rotor, is coaxial with the shaft. For variations including more than one stator, the stators are each separated by a ring which is mounted between successive stators. The air is fed into the top of the turbo-compressor and exits through the bottom thereof.

The rotors are rotatably driven in the same direction as the shaft, as the air is directed onto and through the blades.

The stationary section may include a plurality of successive stators. Each stator comprises a series of vanes spirally arrayed around the center of the central passage. The stator vanes are sandwiched between a pair of stator plates, the vanes directing the air flow from one rotor to the next. The stator is coaxial with the shaft. The stationary section also includes a ring which is mounted between the stators, and which separates the stators. The air is preferably fed into the top of the turbo-compressor and exits through the bottom thereof.

As noted above, the turbo-compressor preferably has five stages, each stage consisting of a rotor and a stator. However, the last stage preferably consists of a rotor only, and no stator. The rotor in the first stage is separated from the rotor in the second stage by the tubular sleeve. If the turbo-compressor has more than one stator, the stator in the first stage is separated from the stator in the second stage by the ring. Preferably, each rotor and each stator are alternatively disposed about the shaft.

As the drive motor is energized, the drive shaft rotates within the turbo-compressor. The rotation of the drive shaft, combined with the air being forced through the air-intake side of the first rotor causes the rotation of the rotor. Air is provided to the top of a turbo-compressor through the housing and below the bonnet. The air leaves the first rotor and is guided inwardly into a second rotor by the vanes of the first stator, the first stator being centrally disposed about the shaft. The air circulates through the stator vanes which are spirally arrayed about the shaft.

As the air fills the housing, it is flung outwardly by the centrifugal force of the rotor. Air flowing into the inlet at the upper end of the turbo-compressor is accelerated and is increasingly compressed in successive stages. The vanes of the first stator guide the air leaving the air-outlet side of the first rotor to the air-inlet side of the second rotor. The guided air impinges upon the blades of each rotor, and then is driven by each rotor around the drive shaft at an increasing speed. The air is increasingly pressurized and accelerated as it leaves each successive rotor. As the air flows downwardly through the turbo-compressor, it is withdrawn therefrom into an outlet or conduit 34.

It is possible that the turbo-compressor be outfitted with air cooled bearings. In such instance, a pair of open ended vertically disposed tubular pipes project vertically through the housing and are fixedly secured within tightly fitted openings in the top wall and the bottom wall of the housing. A flexible wall tube is clamped to the upper end of each pipe to connect the pipes to the extensions of the air inlet to the turbo-compressor.

The lower bearing is located at the end of the shaft below the drive shaft. The opening formed around the series of flanges on the drive shaft is held tight enough to restrict air losses and prevent damage to the internal rotating parts in the event of a failure of the lower bearing.

The lowermost tubular sleeve rests on the topmost flange.

With more particularity, and as shown, the turbo-compressor includes a rotatable section 234 centrally disposed about the drive shaft 216. The section 234 has a first rotor 236 and a second rotor 238. Each rotor 236 and 238 has an air-inlet side 240 and an air-outlet side 242, and a central passage 244. Each rotor 236 and 238 comprises a series of blades 246 spirally arrayed about the passage 244. The blades 246 are sandwiched between a pair of plates 248. The rotors 236 and 238 are rotatably driven in the same direction as the drive shaft 216, as the air is directed onto and through the blades 46. The rotors 236 and 238 are coaxial with the shaft 216. The rotatable section 234 also includes a tubular sleeve 250 which is mounted about the drive shaft 216. The tubular sleeve 250 separates the rotors, and the sleeve 250 is rotatable with the rotors 236 and 238 and the drive shaft 216 in the same direction as the rotors and the drive shaft 216.

The turbo-compressor 214 also includes a stationary section 252, which is also centrally disposed about the drive shaft 216. The stationary section 252 includes a stator 254, which includes a series of vanes 258 spirally arrayed around the center of a central stator passage 260. The vanes 258 are sandwiched between a pair of stator plates 262. The stators are coaxial with the drive shaft 216. If the turbo-compressor includes successive stators, each pair of adjacent stators is separated by a ring 264, which is mounted between the stators 254. The diameter of the ring 264 is considerably larger than the diameter of the tubular sleeve 250. The air is preferably fed into an air inlet at the top of the turbo-compressor 214 and exit through the air outlet or conduit 34 at the bottom thereof.

Preferably, the last stage at the bottom of the turbo-compressor 12 consists only of a rotor 36, since the outlet to the paint spray is in the housing. The rotor in the first stage 36 is separated from the rotor in the second stage 38 by the tubular sleeve 50. The stator in the first stage is separated from the stator in the second stage 56 by the ring. Preferably, each rotor and each stator are alternately disposed about the drive shaft16.

FIG. 5 depicts the direction of air flow. As the drive motor is energized, the motor shaft drives the shaft 216, which rotates within the turbo-compressor 214. The rotation of the drive shaft 216 combined with the air flow being directed into the air-inlet side of the first rotor causes the rotor 236 to rotate about the drive shaft 216.

As air fills the housing, it is flung outwardly by the centrifugal force of the rotor. Air flowing into the inlet at the upper end of the turbo-compressor is accelerated and is increasingly compressed in successive stages. The vanes of the first stator guide the air leaving the air-outlet side of the first rotor to the air-inlet side of the second rotor. The guided air impinges upon the blades of each rotor, and then is driven by each rotor around the drive shaft at an increasing speed. The air is increasingly pressurized and accelerated as it leaves each successive rotor. As the air flows downwardly through the turbo-compressor, it is withdrawn therefrom into the outlet or conduit 34 which is in fluid communication with the paint spray gun or the like (not shown).

The lower bearing of the turbo-compressor may be air cooled. In such arrangement, the bearing 220 is located at the end of the shaft 216 below the drive pulley (not shown). The opening formed around the series of flanges 294 on the drive shaft is held tight enough to restrict air losses and prevent damage to the internal rotating parts in the event of a failure of the lower bearing, while fans (not shown) direct cooling air to the bearing.

Compressing the air as it passes through the turbo-compressor, also, heats the air, raising the air temperature from about 80° to about 240° F. above the ambient temperature of the air entering the turbo-compressor.

It should be noted that, the type of five bladed turbine contemplated for use is commercially available such as that sold by Can-Am Engineered Products, Inc.

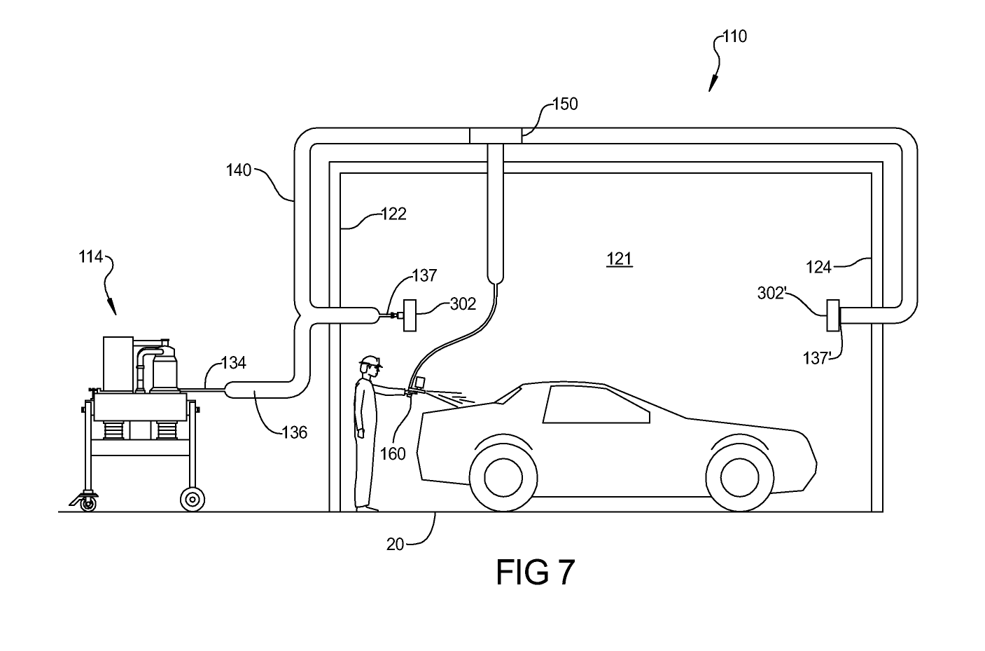

The five bladed turbine or turbo-compressor 14 may be used for both drying and painting of an item, depending on the type of coating. In such instance one of the ducts is connected to the sprayer, e.g. spray gun while the other duct continues to provide heated air to the interior through its associated nozzle (FIG. 7).

Where both drying and spraying are desired, regardless of the nature of the coating, and in accordance herewith, it is preferred that a seven-bladed or seven stage turbine having an air cooled bearing be used herein. This type of turbine is as described above in connection with FIGS. 5 and 6, and is more particularly described in U.S. Pat. No. 4,925,368, the disclosure of which is hereby incorporated by reference.

The seven bladed turbine is, also, commercially available from Can-Am Engineered Products, Inc. and is sold under the trademark Turbo Coat-Air.

When using such a seven bladed turbine and to a lesser degree, a five bladed turbine, noise suppression is important.

To accommodate the flow of air while at the same time suppressing the noise existing in the chamber, a noise suppressor may be suspended below the housing. By diverting some of the air through the motor casing around the bearing housing, a further cooling effect is achieved. The noise created by the drive shaft and the lower bearing, in the event of a bearing failure, signals the operator to shut down the unit.

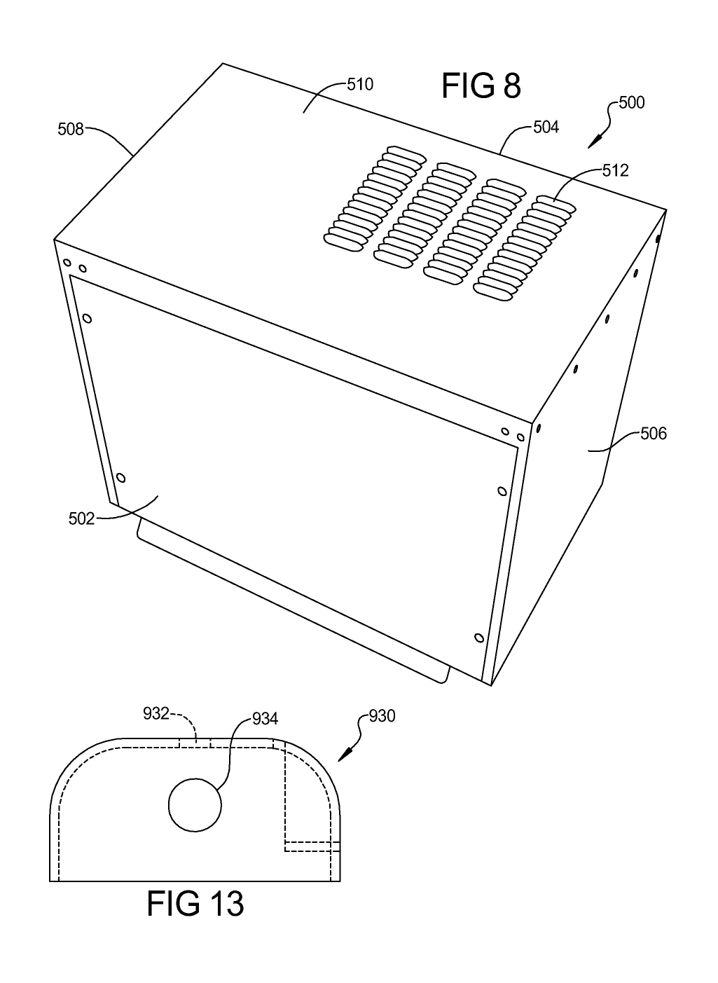

As shown in FIG. 8, a shroud 500 encloses the turbine and compressor, whether the turbine is a five-bladed or seven bladed turbine, to further effectuate noise suppression and is fitted thereover atop the stand. The enclosure or shroud 500 comprises a pair of side walls, 502, 504, a pair of end walls 506, 508 and a top wall 510. The top wall has a plurality of louvers or openings 512 to enable ambient air to enter into the interior of the enclosure for effectuating cooling.

Although not shown in the drawing it is also possible to further suppress noise by enshrouding the intake of each of the compressors with suitable matting, such as foam or the like to further suppress noise.

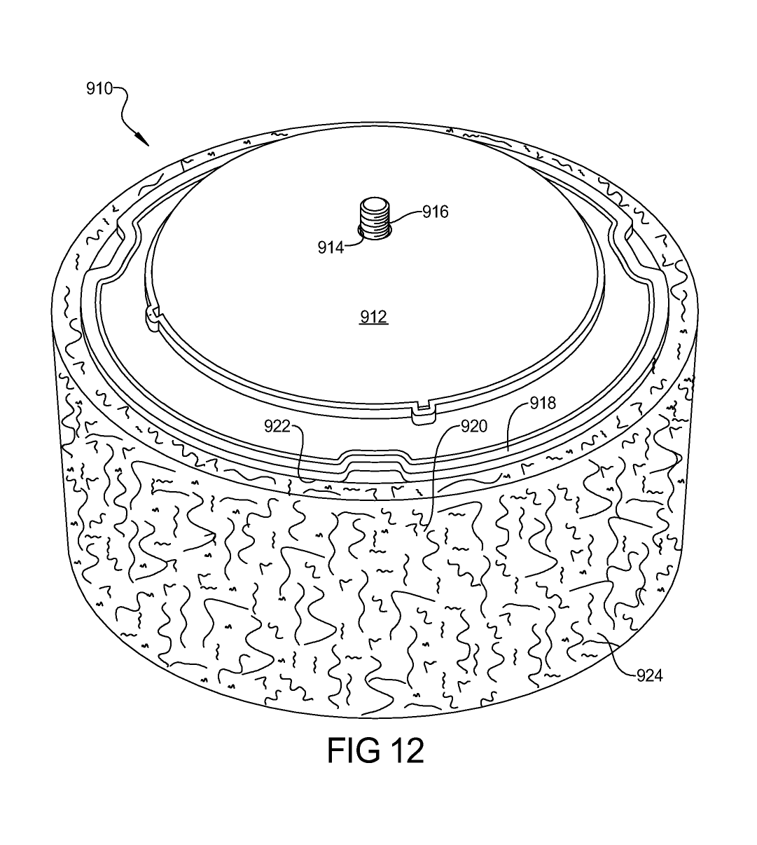

Referring now to FIGS. 12 and 13, there is shown therein the top of the compressor with the cover or dome removed and, generally, shown in 910. The cover is packed with suitable matting to suppress noise as air enters thereinto. Thus, a central foam pad 912 extends from the top of the compressor, to just above the first rotor. The pad 912 is cylindrical with a central aperture 914. A bolt 916 or similar fastener projects therethrough for securing a cover 916 thereto.

A second pad 918 is concentric with and envelops the pad 912. The pad 918 is cylindrical and, like the pad 912, extends from the top of the compressor to above the first rotor.

A filter media 920 encircles the second pad 918 and filters the air entering the compressor from the cover. The filter media is, preferably, a pleated heavy paper or the like. A mesh retainer 922 retains the filter media 920 in place.

A batt or batting 924 surrounds the retainer 922, as shown. The batt comprises any suitable material such as cotton or wool or the like and provides another filter and noise suppressing layer.

It has been found that by using the three layers of noise suppression materials that noise levels are reduces by upwards of forty percent below OSHA regulations.

In FIG. 13 there is shown a preferred cover 930 for the compressor. The cover 930 fits over and enshrouds the filter media, covering all three layers. A central aperture 932 is provided in the cover 930 to enable securement to the central post via a suitable threaded fastener or the like (not shown).

The cover 930 has at least two or more circumferential ports 934 (only one of which is shown) through which ambient air is drawn into the turbo-compressor. The air is drawn into the turbo-compressor and is forced through the filtering media while the noise is suppressed.

Referring now to FIG. 7, and in a second embodiment hereof, where both spraying and drying is desired, a T-diverter 250 is interposed the duct 140 and extends downwardly therefrom exteriorly of the booth. The diverter 150 is operably connected to one or more paint spray guns 160. Where more than one gun is used, the duct is connected to a manifold (not shown) which delivers turbine air to each of the guns. Optimally, the flow of air into the diverter 150 is controlled through a damper or valve (not shown).

A damper or valve controls the air flow. When the damper or valve is open, air flows through the duct 140 to the associated nozzle 137 without air flow through the manifold. When the damper or valve is closed, air flows through the manifold to the gun(s) to enable spraying of paint. Although not critical to the practice of the present invention, the guns themselves may be either automatic or manual.

In practicing the present invention it has been observed that air can flow at a rate of upwards of 1100 fpm when measured at about 12 feet downstream from the sprayer. The temperature of the air issuing from the nozzles ranges from about 80° F. to about 180° F. above the temperature of the air entering the turbo-compressor and can dry an automotive part in about 120 to about 300 seconds.

After the part is dried, which can be sensed through suitable sensors, such as thermocouples or the like, heated air is then exhausted through the booth by opening a standard exhaust damper.

It should be noted that both the five-bladed and the seven-bladed turbines generate sufficient heated air at sufficient velocity to enable an additional paint spray booth to be operably connected thereto. Thus a pair of ducts would extend from a central conduit, such as the conduit 34, with one duct going to a first booth and a second duct extending to a second booth and, then, a similar arrangement, as described above would be provided to the second booth.

It should also be noted that although the present invention has been described within the context of diametrically opposed knives and shields or panels that the number of knives and nozzles as well as the placement thereof can be adjusted to provide for optimal positioning. Similarly, the number of knives is not limited to only one or two. Thus, there can be two or more nozzles which, similarly, can be placed medially of the booth; depending from the roof of the booth; medially of the side walls and so forth. Similarly, the panels, while being described as diametrically opposed and positioned in opposition to the knives can, also, be varied in number and can be similarly placed in different positions within the interior of the booth.

It should be noted, also, that the knife sprayers, themselves, need not be used. Drying air can be introduced in to the interior of the booth directly from the nozzle(s).

It is also to be understood that the present invention can be used to accelerate the drying time of solvent-based coatings or paints.

It is to be appreciated from the preceding that there has been described herein a paint spray booth assembly which expedites the drying of automotive components when spray painted with aqueous based paints.

1. A paint spray booth system comprising:
(a) a booth, the booth including a pair of opposed side walls a front wall and a rear wall,
(b) an access door provided in at least one of the walls,
(c) a turbo-compressor disposed exteriorly of the booth,
(d) means for delivering hot air from the turbo-compressor to the booth,
(e) at least one air knife sprayer disposed within the booth and in fluid communication with the duct, the knife sprayer including at least one air slit for delivering turbulent air into the interior of the booth, and
(f) at least a pair of diametrically opposed panels disposed in opposed corners of the booth, the panels cooperating with the air slit to create a vortex of drying air within the interior of the booth.

2. The paint spray booth of claim 1 wherein the turbo-compressor comprises a five-bladed compressor.

3. The paint spray booth of claim 1 wherein which further comprises:
a reduced diameter nozzle disposed within the booth and connected to the duct, the knife sprayer being mounted over the nozzle.

4. The paint spray booth of claim 3 wherein the knife sprayer comprises:
(a) a substantially cylindrical body having a first end and a second end,
(b) the at least one air slit,
(c) a top plate and a bottom plate,
(d) a nozzle disposed within the interior of the knife and having a tapered reduced diameter portion.

5. The paint spray booth of claim 1 wherein the turbo-compressor comprises:
(a) a housing,
(b) a rotatable, vertically disposed drive shaft centrally disposed within the housing,
(c) a bearing housing,
(d) a concentric bearing disposed in the housing,
(e) a rotatable section centrally disposed about the shaft and including a first and second rotor coaxial with the shaft, each rotor comprising a first series of blades spirally arrayed about the center of the shaft.

6. The paint spray booth of claim 5 wherein, the rotor further comprises:
(a) a pair of first and second plates centrally disposed about the shaft,
(b) a tubular sleeve mounted about the shaft for separating the rotors and rotatable therewith,
(c) a stationary section centrally disposed about the shaft and including a stator which comprises a series of vanes spirally arrayed around the center of the central passage, the stator being coaxial with the shaft, and wherein the first series of blades is sandwiched between the first and second plates.

7. The paint spray booth of claim 6 wherein, the turbine comprises five stages, at least four of the stages comprising a rotor and a stator, at least one stage comprising solely a rotor.

8. The paint spray booth of claim 1 wherein the turbo-compressor comprises:
(a) a compressor section disposed above the turbine portion thereof,
(b) a first foam matting pad disposed within the compressor and concentrically mounted about the drive shaft,
(b1) a second foam concentric with the first foam pad,
(c) an air filter concentric with the first and second pads, and
(d) a third outer batt concentric with the first and second filters, the pads, batt and the air filter defining means for suppressing noise.

9. The paint spray booth of claim 8 wherein the turbo-compressor further includes a cover overlying the pads and the air filter, the cover being removably secured to the drive shaft and having at least a pair of air inlet ports.

10. The paint spray booth of claim 1 which further comprises a T-diverter interposed the duct, at least one spray gun disposed within the booth, the spray gun being in fluid communication with the T-diverter for delivering turbine air to the gun.
